(19) United States
(12) Patent Application Publication
(10) Pub. No.: US 2015/0248712 A1
(43) Pub. Date: Sep. 3, 2015

(54) SYSTEMS AND METHODS FOR PROVIDING MOBILE ADVERTISEMENTS

(71) Applicant: Yahoo! Inc., Sunnyvale, CA (US)

(72) Inventors: Rupert Christopher Lacy-Hulbert, Pewsey (GB); Bruno M. Fernandez-Ruiz, Mountain View, CA (US)

(73) Assignee: Yahoo! Inc., Sunnyvale, CA (US)

(21) Appl. No.: 14/194,205

(22) Filed: Feb. 28, 2014

(51) Int. Cl. G06Q 30/02; H04M 3/487

(52) U.S. Cl. CPC G06Q 30/0276; G06Q 30/0267; H04M 3/4878

(57) ABSTRACT

Systems and methods for providing mobile advertisements are disclosed. The system includes a plurality of templates to be selected by an advertiser. The system also includes a user interface configured to present the plurality of templates to the advertiser so that the advertiser selects a template. The user interface is further configured to obtain advertiser information corresponding to the selected template. The system includes data that define a mobile advertisement related to the advertiser on a mobile device so that the mobile device is configured to render a mobile view on the mobile device based on the selected template and the obtained advertiser information when the mobile advertisement is selected.

### BACKGROUND

Online advertising, also called Internet advertising, uses the Internet to deliver promotional marketing messages to consumers. Online advertising is a large business and is growing rapidly. Online advertising revenues in the United States surpassed those of cable television and nearly exceeded those of broadcast television in 2011.

Online advertising includes email marketing, search engine marketing, social media marketing, many types of display advertising, and mobile advertising. Online advertising usually involves both a publisher, who integrates advertisements into its online content, and an advertiser, who provides the advertisements to be displayed on the publisher's system. The publisher may be a

As mobile devices become more and more popular, more publishers and advertisers are interested to adopt mobile advertising in their businesses. Mobile advertising may be the fastest growing advertising in the world. While a few companies provide a mobile version or mobile application (“app”) when people visit their web sites through mobile devices, there are lots of small businesses who don't have a webpage or mobile application tailored for mobile access. As a result, mobile advertising may not have the desired conversion rate for those small businesses.

Thus, to take advantage of mobile advertising, small businesses need an advertising system that provides the desired conversion without the time and expense required for developing a mobile app or mobile webpage. It would be desirable to develop such new systems and methods for small businesses to increase the conversion rate without increasing the cost of the small businesses.

### SUMMARY

In the disclosed system and method, mobile templates are introduced to enhance mobile landing experience. When a mobile advertisement is tapped, clicked or otherwise selected or actuated, a native mobile view is presented by combining a mobile template and corresponding advertiser information. Thus, the advertising system may increase the conversion rate and track the cost per action (CPA) more accurately.

In a first aspect, a computer system is disclosed for providing mobile advertisements. The computer system includes a processor and a non-transitory storage medium accessible to the hardware processor. The system includes a plurality of templates to be selected by an advertiser. The system also includes a user interface configured to present the plurality of templates to the advertiser so that the advertiser selects a template. The user interface is further configured to obtain advertiser information corresponding to the selected template. The system is configured to provide data to a mobile device that defines a mobile advertisement so that the mobile device may display a mobile advertisement related to the advertiser on the mobile device. The system is configured to render a mobile view on the mobile device based on the selected template and the obtained advertiser information when the mobile advertisement is selected.

In a second aspect, a method or program is disclosed for providing mobile advertisements implemented in a computer system. In the computer implemented method, the system provides a plurality of templates to be selected by an advertiser. The system obtains a selection of one of the plurality of templates. The system obtains advertiser information corresponding to the selected template. The system provides to a mobile device, data that defines a mobile advertisement related to the advertiser so that the mobile device renders a mobile view on a display of the mobile device when the mobile advertisement is selected. The mobile view on the mobile device is rendered based on the selected template and the obtained advertiser information.

In a third aspect, a non-transitory storage medium is configured to store a set of instructions. The set of instructions directs a computer system to perform the acts of the method in the second aspect.

### BRIEF DESCRIPTION OF THE DRAWINGS

FIG. 1 illustrates a block diagram of one embodiment of an environment in which a system for providing mobile advertisements may operate;

FIG. 2 illustrates an example device for providing mobile advertisements;

FIG. 3 illustrates an example system for providing mobile advertisements;

FIG. 4 illustrates an example block diagram illustrating one embodiment of the disclosure; and

FIGS. 5A-5C illustrate example templates in an example advertising system of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

For web portals like Yahoo!, the advertising system may include a plurality of websites and a plurality of mobile applications. Both the websites and the mobile applications may display online advertisements on mobile devices such as smartphones, tablets, phablets, or other mobile computing devices. The mobile device may have a relatively smaller display screen size compared to regular personal computers or laptops. For example, most smartphones have a display screen size that is 5 inches or less while most personal computers have a display screen size that is 14 inches or larger.

Generally, when the advertiser does not have a mobile application or a mobile webpage, the same advertiser webpage will be loaded and displayed on the regular personal computer and the mobile device when a user clicks or taps an advertisement. In that case, the advertiser webpage may be difficult to navigate because the buttons and texts are tiny when shown on the display screen on the mobile devices. The mobile device user may have to zoom in several times to find the desired information. The poor mobile landing experience may result a poor conversion rate because it takes too much time and effort to access such webpages on a mobile device.

One of the current solutions to this problem is to develop a mobile application or a mobile webpage tailored for mobile display on the small display screens. However, most small businesses do not have the financial resources or technical expertise to develop a mobile application or a mobile webpage for their businesses. At the meantime, the small business owners would like to enjoy the additional income from mobile advertisements.

To solve the above problem, an advertising system is provided to improve the mobile landing experience by providing advertisers with templates associated with desired actions to be performed by users. The advertisers only need to select the appropriate templates with the desired action to be performed when they buy or bid mobile advertisements. The advertising system then presents the selected template and the advertiser information in a mobile view when a mobile advertisement is selected by a mobile device user. The mobile view displays the selected template according to the screen size and settings on the mobile device and thus provides a native in-app experience to mobile device users without opening a webpage in a web browser. The mobile view also provides large action buttons or menus that allow users to select or click with a single hand. Thus, the mobile device user can easily access the desired information in the mobile view about the advertiser without zooming or pinching.

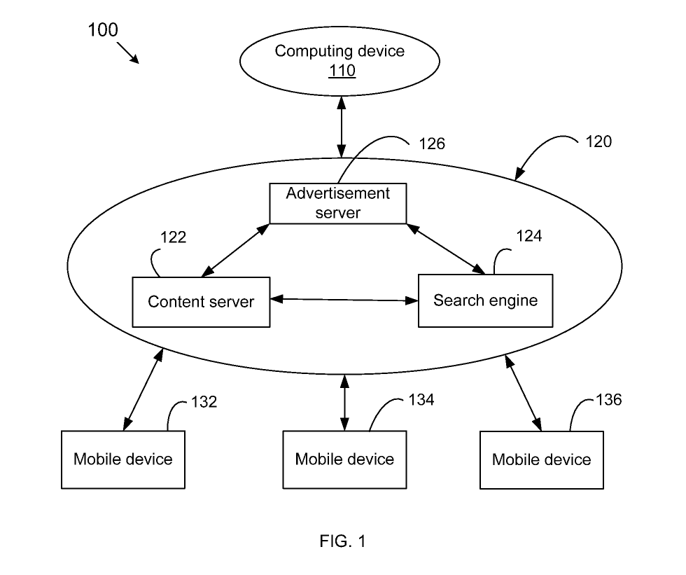

FIG. 1 illustrates a block diagram of one embodiment of an environment 100 in which a system for providing mobile advertisements may operate. However, it should be appreciated that the systems and methods described below are not limited to use with the particular exemplary environment 100 shown in FIG. 1 but may be extended to a wide variety of implementations.

The environment 100 may include a computing device 110 and a connected server system 120 including a content server 122, a search engine 124, and an advertisement server 126. The server system 120 may include additional servers for additional computing or service purposes. For example, the server system 120 may include servers for social networks, online shopping sites, and any other online services.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser.

The computing device 110 and the connected server system 120 may have access to a database system. The database system may include one or more databases. For example, one database may include advertiser information such as advertiser address, phone number, et al. A second database may include user information related to a social network and past search histories. The computing device 110 may be a computer, a laptop, a tablet, or any other device that an advertiser may use to access the Internet and buy online advertisements.

The environment 100 may further include a plurality of mobile devices 132, 134, and 136. The mobile devices 132, 143, 136 may be embodied as a smartphone, a personal digital aid, a digital reader, a Global Positioning System (GPS) receiver, or any other device that mobile users may use to access the Internet to find desired information. The mobile devices 132, 143, 136 may have a relatively smaller screen size compared with the computing device used by advertisers.

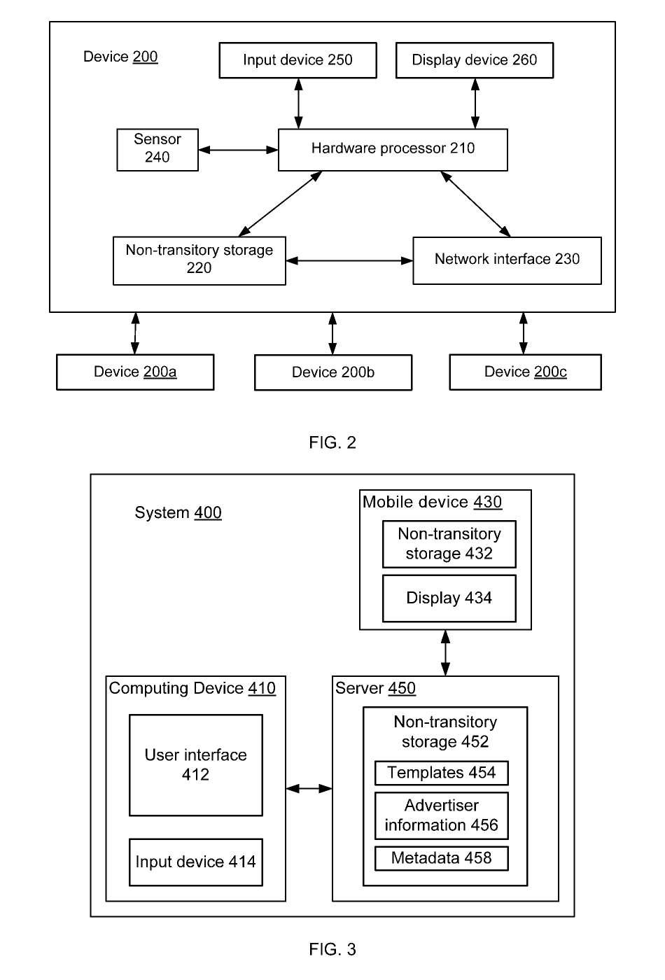

FIG. 2 illustrates an example device 200 for providing mobile advertisements. The device may 200 may be a mobile device such as a smartphone, a tablet, or any other computing device including a hardware processor 210, a non-transitory storage medium 220, and a network interface 230. The hardware processor 210 accesses the programs and data stored in the non-transitory storage medium 220. The device 200 may further include at least one sensor 240 such as light sensors, touch sensors, cameras, Bluetooth sensors, wireless sensors, communication sensors, gyroscope sensors, and any other sensors used to detect an environmental or operational condition in devices such as smartphones. The device 200 may also include an input device 250 and a display device 260. The input device 250 may include a touch screen, a button, a switch, or external input devices. The display device 260 may include a liquid crystal display, a light-emitting diode (LED) display, an organic light-emitting diode (OLED) display, or other known displays in mobile devices. The device may communicate with other devices 200a, 200b, and 200c via the network interface 230 or sensors 240.

The device 200 may implement one or more application programs or applications or apps. The applications may include program and code stored in the non-transitory storage medium 220 for operation on the hardware processor 210. The applications may operate in conjunction with sensors such as the sensor 240 and a user interface of the device 200 including the input device 250 and display device 260. The applications may further operate in conjunction with programs and data on remote processing systems such as servers operated by an online service provider or an advertiser to provide information to a user of the device 200 or collect inputs and operational information from the device 200.

FIG. 3 illustrates an example system 400 for providing mobile advertisements. The example system 400 includes a computing device 410, a mobile device 430, and a server 450, which are connected by Internet or other communication network. The computing device 410, a mobile device 430, and a server 450 are configured to communicate data when connected to a communication network.

The computing device 410 may be a computer, a laptop, a tablet, or any other computing device accessible to an advertiser. The computing device 410 communicates with the server 450 to obtain a plurality of templates to be selected by the advertiser. For example, the computing device 410 may include a user interface 412 that presents the plurality of templates to the advertiser so that the advertiser selects a template. The user interface 412 may include any suitable data display devices, such as a liquid crystal display (LCD) screen and any suitable data entry devices such as a keypad, microphone or touch-sensitive display screen. The user interface 412 may be based on a webpage rendered by a browser or an application installed on the computing device 410. The user interface 412 is further configured to obtain advertiser information corresponding to the selected template. The advertiser may input the advertiser information using an input device 414 such as a keyboard, a microphone, a mouse, or any other known input device.

The mobile device 430 may be a smartphone, a tablet, or any other mobile computing device accessible to a mobile user. The mobile device 430 includes a non-transitory storage 432 and a display 434. The non-transitory storage 432 is configured to store different mobile applications. For example, the non-transitory storage 432 stores a mobile application from a publisher or an advertising service provider that manages the system 400. The mobile device 430 communicates with the server 450 to obtain mobile advertisements candidates from the server 450. The mobile device may also obtain other metadata from the server 450 so that the mobile device can display the mobile advertisement with the corresponding advertiser information the mobile application is running. If the mobile user clicks or taps or otherwise selects the displayed mobile advertisement, the mobile application renders a mobile view on the mobile device based on the selected template and the obtained advertiser information.

When the user performs the desired action shown in the mobile view, the mobile application may track the performed actions and send the tracking information back to the server 450. The server 450 records those tracking information and updates the CPA. Further, the server 450 may provide the recorded tracking information to the advertiser.

The server 450 may be a server computer, a cluster, or any computing devices that include a non-transitory storage 452. The server 450 generally includes a data processing system with a processor and memory to store data and instructions. The non-transitory storage 452 stores the plurality of templates 454, the advertiser information 456, and metadata 458. The metadata 458 includes necessary information to render the mobile view on a particular mobile device.

The server 450 obtains the advertiser information from the device 410 and stores the advertiser information for each advertiser. When the mobile device requests advertisement candidates, the server may then provide template indexes to the selected templates and the corresponding advertiser information and the necessary metadata to the mobile device 430 so that the mobile device can present a mobile view with such information.

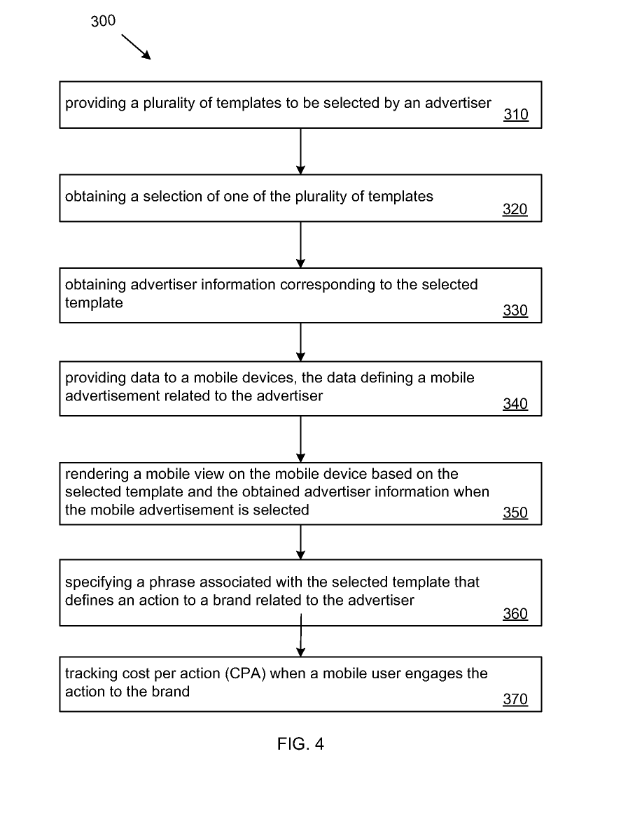

FIG. 4 illustrates an example flow diagram 300 illustrating one embodiment of a method for providing mobile advertisements in an advertising system. In an example embodiment, the advertising system may include a computing device 410, a mobile device 430, and a server 450 as illustrated in FIG. 3.

In step 310, the system provides a plurality of templates to be selected by an advertiser. A template may be a master advertising page used to produce a mobile view optimized for viewing on mobile devices. The template may include information from advertisers such as advertiser graphical images, advertiser selectable text, advertiser selectable shapes or designs. The template may further include information that may be customized by mobile users to specify a font size, a background color, etc.

For example, the system may provide a plurality of templates to an advertiser on a computing device such as computing device 410 shown in FIG. 3. The template may include a data file including data, instructions or both suitable to render on a display of a device of the advertiser a graphical or textual image, or both, representing an advertisement that may be customized by the advertiser. Each template may be customized for a specific action to be performed by a mobile user. In one exemplary embodiment, the advertiser can select one or more templates for the desired actions to be performed related to a brand of the advertiser. The actions may include at least one of the following: navigating to a store of the brand, calling a phone number related to the advertiser, setting a calendar event related to the advertiser, obtaining a coupon of the brand, and sharing a message of the brand on a social network. These actions are intended to be exemplary. In other embodiments, an advertiser can customize the template in the widest variety of manners.

For example, a coffee shop owner may desire mobile users to visit his coffee shop and thus would welcome mobile users to navigate to a web site or other online information about his coffee shop with a single click or tap. Further, the coffee shop owner may give coupons to promote his coffee or breakfasts. Thus, the coffee shop owner may also like any potential customer to download a coupon of the brand. Furthermore, after the mobile users visit the coffee shop and enjoyed the service and food in the coffee shop, the shop owner would be more than happy if the mobile users share their good experience with the brand on a social network.

In another example, a restaurant owner or car repair shop would welcome any mobile users to call their business telephone number to set up reservations or appointments. Once a reservation is made, the mobile user may tap a button displayed on the display of a smart phone to set a calendar event for the future visit on a calendar application of the mobile device or a remotely located calendar application.

For advertisers that accept online reservations, the advertisers may welcome the mobile user to set a calendar event related to the advertiser by a single tap or click of an actuator of a smart phone or other device, such as a soft button displayed on the screen of a smartphone.

In step 320, the system obtains a selection of one of the plurality of templates. The advertiser may use a computing device to select one or more templates through a user interface tailored for the computing device. For example, the user interface may be different on a personal computer and a tablet. Each template may be identified by a template index. Thus, the template index of the selected templates may be stored in an advertisement server so that the advertisement server may provide the template index to a mobile device when a related mobile advertisement is provided as an advertisement candidate to the mobile device.

In step 330, the system obtains advertiser information corresponding to the selected template. Each template may correspond to a specific action and thus may requires additional information from the advertiser. The additional information may include at least one of the following: an image related to the advertiser, a title related to the advertiser, an address related to the advertiser; a promotion text related to the advertiser, and a phone number related to the advertiser.

In step 340, the system provides data to a mobile device, where the data define a mobile advertisement related to the advertiser. The server 450 in FIG. 3 may provide to the mobile device 430 mobile advertisement candidates so that the mobile device 430 may display the mobile advertisement related to the advertiser when certain preset conditions are met.

In an example embodiment, a mobile device may include a processor and a non-transitory storage medium that stores a mobile application from the publisher that manages the advertising system. The non-transitory storage medium may also store the plurality of templates specifically tailored for the screen size of the mobile device. This may be implemented when the mobile application is built and installed in the mobile device.

The mobile application may provide an email service, a news service, a weather service, or a social network service to mobile users. When the mobile application is activated, the mobile application may communicate with an advertisement server or other servers illustrated in FIG. 1. The mobile application may request the server to provide mobile advertisement candidates to show on the mobile device. In response to the request, the server provides data that define mobile advertisements. Because both the mobile device and the advertisement server stores the same number of templates, the advertisement server may only need to send the template index of the selected template and the corresponding advertiser information to the mobile application. The server may also need to send metadata related to the mobile device so that the template can be resized to file the screen size of the mobile device. This method not only reduces data usage and loading time to provide mobile advertisements but also reduces loading time to provide the necessary advertiser information to the mobile user after the mobile advertisement is selected.

In step 350, the system renders a mobile view on the mobile device based on the selected template and the obtained advertiser information when the mobile advertisement is selected. For example, the mobile application may render a mobile view of the template that fully fit the screen size of the mobile device with buttons or menus that can be conveniently selected by the mobile users. The mobile application does not need to open a webpage from the advertiser in this case. Rather, the mobile application only presents the selected template with the corresponding metadata including advertiser information. At least some of the texts are displayed in a font size specified by a setting of the mobile device. There is no need for mobile users to zooming in to find the desired information. Thus, the advertising system increases the conversion rate by providing the native in-app experiences to the mobile users.

In step 360, the system specifies a phrase associated with the selected template that defines an action to a brand related to the advertiser. For example, the advertiser may select a particular action to be performed that is related to his store. Alternatively or additionally, the advertising service provider may specify predetermined actions to a template so that the advertiser can just make one selection of both the template and the action to be performed. Further, the mobile device may have settings that can change or modify the options in the actions to be performed. For example, if a social network application is installed and set as the preferred social network on the mobile device, the action to share the advertiser information on a different social network may be replaced with the preferred social network. In other words, the defined action may be customized by one or more devices in the system.

In step 370, the system tracks cost per action (CPA) when a mobile user engages the action to the brand. An advertiser may compensate an advertising service provider based on the cost per action, where an action may include actions defined by the advertiser and any agreed-upon action of a user such as a user of a mobile device. The agreed-upon action may include providing an email address or a credit card number or any other action which may be tracked as a basis for exchanging value. The advertising system may provide the CPA data to advertisers so that the advertisers can select the most effective templates for their businesses. Further, the advertising system may put different prices on each different action or template based on their different conversion rates and CPA data.

For example, a pizza shop may find that the conversion rate is the highest corresponding to the “call to deliver a pizza” template. The pizza shop may be willing to pay more for such template in the future. The publisher may increase the starting bidding price for such templates as well.

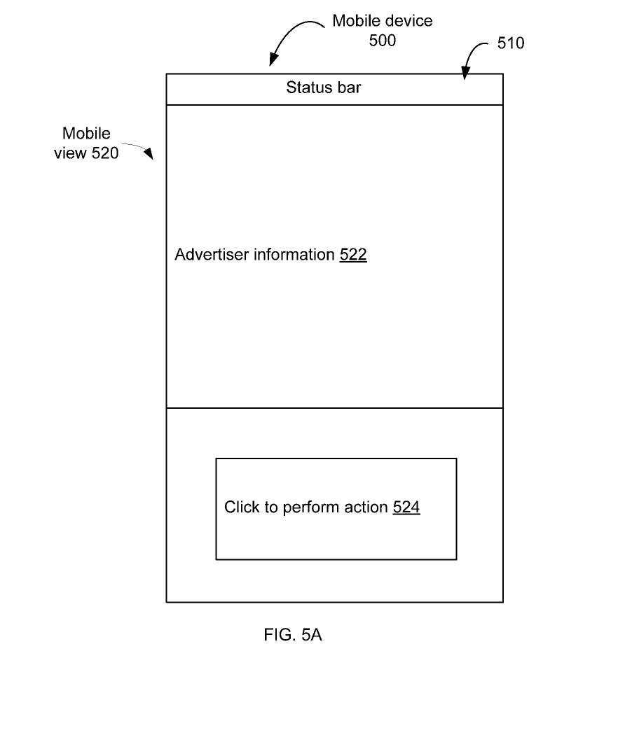

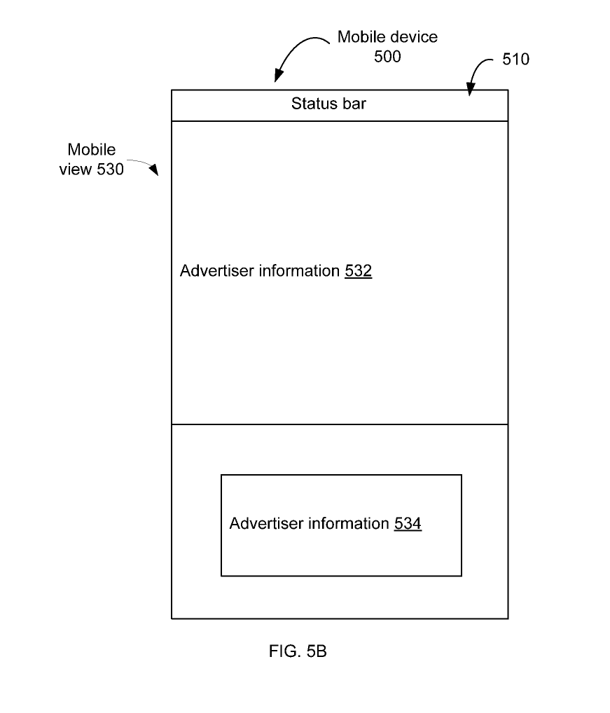

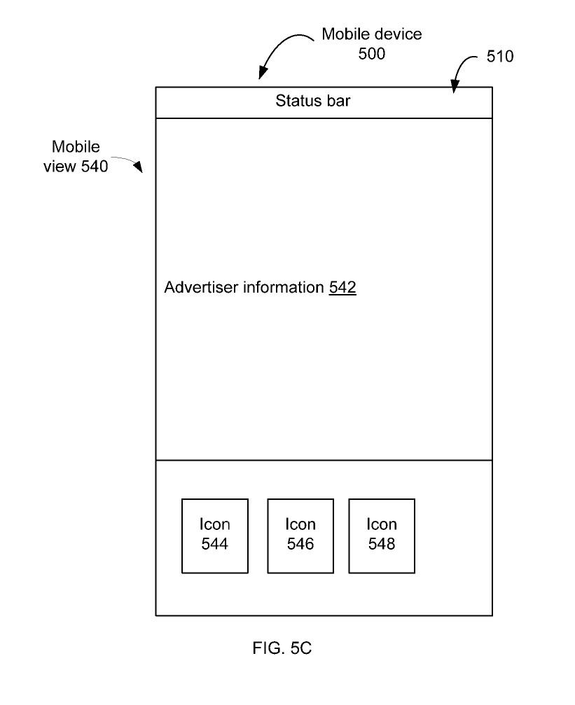

FIGS. 5A-5C illustrate example templates in an example advertising system. FIG. 5A illustrates an example screen shot of a mobile device 500. The screen shot includes a status bar 510 and a mobile view 520. The status bar 510 is shown at the top of the screen and may include carrier information, signal strength, battery level, time, or other system information of the mobile device 500. The mobile view may include two main parts: an upper portion that mainly displays the advertiser information 522 and a lower portion that shows a user selectable actuator such as a button 524.

The advertiser information 522 may include at least one of the following: a brand name of the advertiser, a coupon image of the advertiser, an address of the advertiser, a promotion text related to the advertiser, and a phone number related to the advertiser. The button 524 may display text defining the action to be performed in a relatively large font. Thus, the mobile user only need to tap or click the button 524 to perform the specified action shown in the advertiser information 522.

FIG. 5B illustrates an example screen shot of a mobile device 500. The screen shot includes a status bar 510 and a mobile view 530. The mobile view 530 is slightly different from the mobile view 520 of FIG. 5A. One difference is that the mobile view 530 may present advertiser information 532 and 534 in both the upper portion the mobile view 530 and the lower portion of the mobile view 530. For example, the advertiser information 532 in the upper portion may show a brand name with a store address and promotion text, the advertiser information 534 in the lower portion may present a coupon image tailored to the mobile user. The mobile user can select the store address in the upper portion to navigate to the store. The mobile user may select the coupon image to download the coupon for future use.

FIG. 5C illustrates an example screen shot of a mobile device 500. The screen shot includes a status bar 510 and a mobile view 540. The mobile view 540 is slightly different from the mobile view 520 in that the upper portion has a larger area that shows the advertiser information. Further, the lower portion shows a plurality of icons 544, 546, and 548. Each icon 544, 546, and 548 may perform any assigned function which is controlled by stored program code and data. In one embodiment, each icon 544, 546, and 548 may identify a method of sharing the advertiser information 542 shown in the upper portion of the mobile view. For example, the icon 544 may be associated with sharing the advertiser information 544 via email. The icon 546 may be associated with sharing the advertiser information 544 via a social network. The icon 548 may be associated with sharing the advertiser information 544 via a second social network. The particular associations and the operations performed by the mobile device are controlled by programming code and data stored, for example, in the mobile device.

The templates of FIGS. 5A, 5B and 5C are intended for illustration purpose only. The templates may include additional actuators or buttons such as “Done” or “Cancel” in relatively large fonts and can be selected by the mobile user with a single touch or tap.

The disclosed system and method provide many advantages. For example, when making use of the disclosed system and method, advertisers do not need to prepare a mobile web site or a mobile application suitable for mobile use. This reduces the cost and time investments of getting online advertisements prepared for display to users. The advertiser can select a template in the mobile application and specify an associated action to be performed by a potential customer. The advertiser only needs to enter a few data elements to provide a native mobile experience for potential customers. Further, the computer system can directly track cost per action (CPA) within the mobile application.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising a processor and a non-transitory storage medium accessible to the processor, the system comprising:
a plurality of templates to be selected by an advertiser;
a user interface configured to present the plurality of templates to the advertiser so that the advertiser selects a template, the user interface further configured to obtain advertiser information corresponding to the selected template;
data defining a mobile advertisement related to the advertiser that is configured to be displayed on a mobile device; and
a mobile view configured to be rendered on the mobile device based on the selected template and the obtained advertiser information when the mobile advertisement is selected.

2. The system of claim 1, wherein at least one of the plurality of templates comprises a phrase that specifies an action to a brand related to the advertiser.

3. The system of claim 2, wherein the system is further configured to track cost per action (CPA) when a mobile user engages the specified action to the brand.

4. The system of claim 2, wherein the action to the brand related to the advertiser comprises at least one of the following:
navigating to a store of the brand,
calling a phone number related to the advertiser,
setting a calendar event related to the advertiser,
obtaining a coupon of the brand, and
sharing a message of the brand on a social network.

5. The system of claim 1, wherein the advertiser information comprises at least one of the following:
an image related to the advertiser,
a title related to the advertiser,
an address related to the advertiser;
a promotion text related to the advertiser, and
a phone number related to the advertiser.

6. The system of claim 1, wherein the mobile view displays texts having a font size specified by a setting of the mobile device.

7. The system of claim 1, wherein the mobile view displays the selected template that fully fits a screen size of the mobile device.

8. The system of claim 1, wherein the processor is configured to provide metadata to the selected template.

9. A method for providing mobile advertisements, comprising:
providing, by one or more devices comprising a processor, a plurality of templates to be selected by an advertiser;
obtaining, by the one or more devices, a selection of one of the plurality of templates;
obtaining, by the one or more devices, advertiser information corresponding to the selected template; and
providing, by the one or more devices, to a mobile devices, data that define a mobile advertisement related to the advertiser so that the mobile device renders a mobile view on a display of the mobile device when the mobile advertisement is selected,
wherein the mobile view is rendered based on the selected template and the obtained advertiser information.

10. The method of claim 9, further comprising:
specifying, by the one or more devices, a phrase associated with the selected template that defines an action to a brand related to the advertiser.

11. The method of claim 10, further comprising:
tracking, by the one or more devices, cost per action (CPA) when a mobile user engages the action to the brand.

12. The method of claim 9, wherein the action to the brand related to the advertiser comprises at least one of the following:
navigating to a store of the brand,
calling a phone number related to the advertiser,
setting a calendar event related to the advertiser,
obtaining a coupon of the brand, and
sharing a message of the brand on a social network.

13. The method of claim 9, wherein the advertiser information comprises at least one of the following:
an image related to the advertiser,
a title related to the advertiser,
an address related to the advertiser;
a promotion text related to the advertiser, and
a phone number related to the advertiser.

14. The method of claim 9, further comprising: displaying texts of the mobile view in a font size specified by a setting of the one or more devices.

15. The method of claim 9, further comprising: displaying the selected template in the mobile view that fully fits a screen size of the mobile device.

16. The method of claim 9, further comprising:
providing, by the one or more devices, metadata to the selected template so that the one or more devices renders the mobile view completely.

17. A non-transitory storage medium configured to store a set of instructions, the set of instructions to direct a computer system to perform acts of:
providing, by the computer system, a plurality of templates to be selected by an advertiser;
obtaining, by the computer system, a selection of one of the plurality of templates;
obtaining, by the computer system, advertiser information corresponding to the selected template;
providing, by the computer system, data that define a mobile advertisement related to the advertiser; and
rendering, by the computer system, a mobile view based on the selected template and the obtained advertiser information when the mobile advertisement is selected.

18. The non-transitory storage medium of claim 17, wherein the set of instructions to direct the computer system to perform acts of:
specifying, by the one or more devices, a phrase associated with the selected template that defines an action to a brand related to the advertiser; and
tracking, by the one or more devices, cost per action (CPA) when a mobile user engages the action to the brand.

19. The non-transitory storage medium of claim 17, wherein the action to the brand related to the advertiser comprises at least one of the following:
navigating to a store of the brand,
calling a phone number related to the advertiser,
setting a calendar event related to the advertiser,
obtaining a coupon of the brand, and
sharing a message of the brand on a social network.

20. The non-transitory storage medium of claim 17, wherein the advertiser information comprises at least one of the following:
an image related to the advertiser,
a title related to the advertiser,
an address related to the advertiser;
a promotion text related to the advertiser, and
a phone number related to the advertiser.
